(19) United States
(12) Patent Application Publication
(10) Pub. No.: US 2009/0167719 A1
(43) Pub. Date: Jul. 2, 2009

(54) GESTURE COMMANDS PERFORMED IN PROXIMITY BUT WITHOUT MAKING PHYSICAL CONTACT WITH A TOUCHPAD

(76) Inventor: Richard D. Woolley, Orem, UT (US)

Correspondence Address: MORRISS OBRYANT COMPAGNI, P.C., 734 EAST 200 SOUTH, SALT LAKE CITY, UT, 84102, US

(21) Appl. No.: 12/264,209

(22) Filed: Nov. 3, 2008

Related U.S. Application Data
(60) Provisional application No. 60/985,121, filed on Nov. 2, 2007.

(51) Int. Cl. G06F 3/045

(52) U.S. Cl. 345/174

(57) ABSTRACT

A method of using proximity sensing to detect and track movement of a detectable object that is making a gesture in a three-dimensional volume of space in a detection volume of a proximity sensitive touchpad.

### CROSS REFERENCE TO RELATED APPLICATIONS

This document claims priority to and incorporates by reference all of the subject matter included in the provisional patent application docket number 3988.CIRQ.PR, having Ser. No. 60/985,121 and filed on Nov. 2, 2007.

### BACKGROUND OF THE INVENTION

1. Field of the Invention

This invention relates generally to touchpads. More specifically, the present invention is a method of using a proximity or far field sensing device, such as a touchpad that includes the capability of proximity sensing.

2. Description of Related Art

There are several designs for capacitance sensitive touchpads. One of the existing touchpad designs that can be modified to work with the present invention is a touchpad made by CIRQUE® Corporation. Accordingly, it is useful to examine the underlying technology to better understand how any capacitance sensitive touchpad can be modified to work with the present invention.

The CIRQUE™ Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing. Either design will enable the present invention to function.

### BRIEF SUMMARY OF THE INVENTION

In a preferred embodiment, the present invention is a method of using proximity sensing to detect and track movement of a detectable object that is making a gesture in a three-dimensional volume of space in a detection volume of a proximity sensitive touchpad.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of operation of a first embodiment of a touchpad that is found in the prior art, and which is adaptable for use in the present invention.

FIG. 2 is a top down view of a touchpad and a detectable object within a detection volume.

FIG. 3 is a perspective view of a touchpad at the center of a detection volume.

FIG. 4 is a perspective view of a touchpad that is now on the edge of a detection volume.

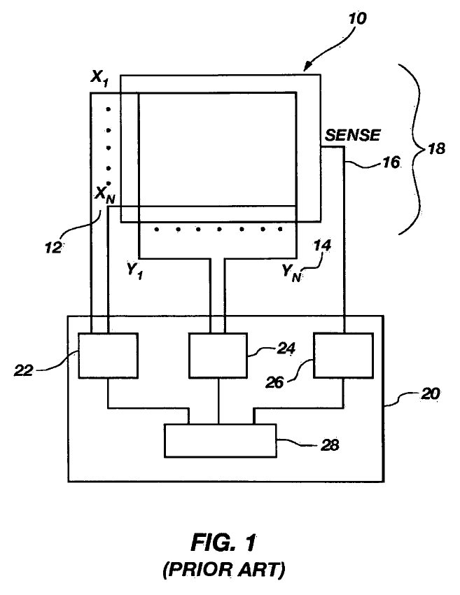

### DETAILED DESCRIPTION OF THE INVENTION

Reference will now be made to the details of the invention in which the various elements of the present invention will be described and discussed so as to enable one skilled in the art to make and use the invention. It is to be understood that the following description is only exemplary of the principles of the present invention, and should not be viewed as narrowing the claims which follow.

Prior art touchpad technology most often requires the user to make contact with a touch-sensitive surface to activate a control and perform functions such as gestures, tapping, cursor control, scrolling, activating buttons or performing wake-up functions.

The present invention provides an interface that does not require the user to physically make contact with a touchpad in order to input a command. With a proximity sensitive device, the user may perform a gesture in the volume above the touchpad (in three dimensional space) to input a command such as a wake-up function, scrolling, page turning, or other gesture that currently requires touch in order to input the command. These examples should not be considered limiting and the gestures that can be performed in three-dimensional space can be any movement of a detectable object.

The touchpad hardware that is capable of performing proximity sensitive detection is provided by CIRQUE® Corporation and is not considered to be an aspect of the present invention. Any touchpad that can provide the desired proximity sensing capability can be used by the present invention. Thus, what is important to understand is that the present invention uses advances in touchpad technology that enables touchpads to detect and track movement of objects in a three-dimensional space, which can also be referred to as a detection volume. The present invention is an application of the new touchpad technology.

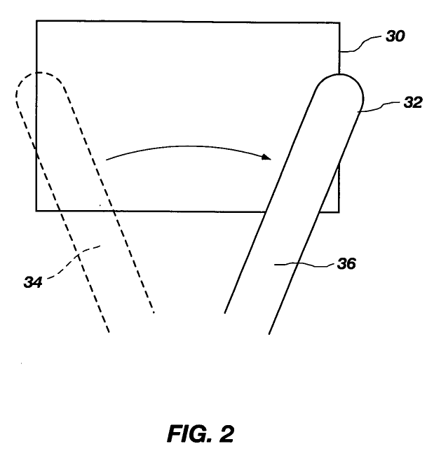

The gestures that can be performed in three-dimensional space need to be performed within the detection volume of a touchpad. FIG. 2 is provided as a first embodiment of how a gesture can be performed. FIG. 2 shows a proximity sensitive touchpad 30. The touchpad 30 can perform proximity sensing only, or a combination of proximity and touch sensing capabilities.

Touchpad 30 is shown as it would be seen when looking down on the touchpad from above, and a detectable object 32 is shown over the touchpad 30. The detectable object 32 could be any object that is detectable by the touchpad technology being used. In the case of a touchpad from CIRQUE® Corporation, the touchpad uses capacitance-sensing technology. The detectable object 32 in this example is a stylus or hand-held wand, and is used for illustration purposes only. The user could as easily have used a hand or finger instead.

The detectable object 32 is shown moving from a first position 34 to a second position 36. The detectable object 32 has moved within a detection volume of three-dimensional space over the touchpad 30. The detectable object 32 did not have to be directly over the touchpad 32 in order to be detected. The detection volume of the touchpad 30 will depend upon its own proximity sensing capabilities.

It is noted that the motion of the detectable object 32 is a typical swiping motion. The swiping motion could also have been repeated back-and-forth, or repeated in a single direction by moving the detectable object 32 outside the detection volume and then repeating the same motion.

The specific dimensions of a detection volume are probably not going to be precisely defined but fade out with increasing distance from the touchpad 30. Reliable detection volumes might be within 10 cm of the touchpad 30, or 10 meters. The limits depend upon the proximity sensing technology, and not the present invention.

Because the proximity sensing capabilities of the touchpad 30 are not an element of the invention, it is sufficient to state that the touchpad has some detection volume of three-dimensional space within which objects can be detected, and the specific dimensions of that volume are not important.

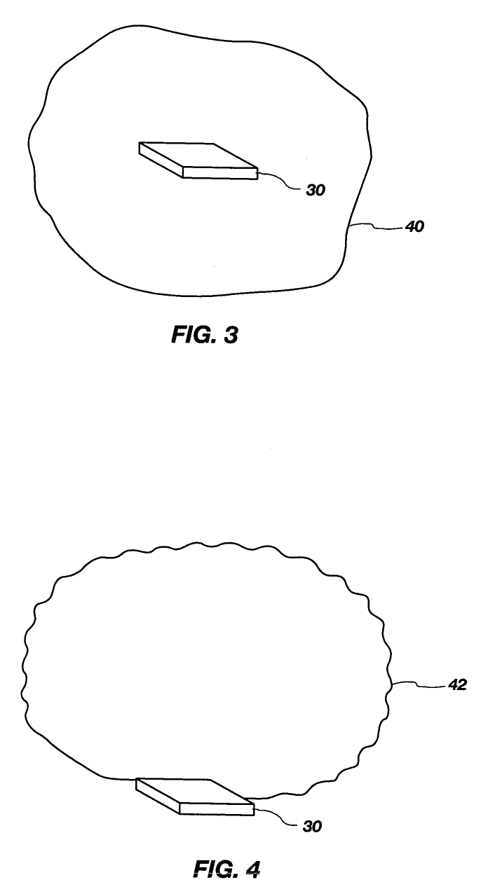

Another aspect of the invention is that the detection volume might have the touchpad 30 at the very center, or the detection volume might extend from one side only of the touchpad. FIG. 3 illustrates the touchpad 30 that is disposed within a detection volume 40. The touchpad 30 may or may not be centered. FIG. 4 illustrates the touchpad 30 that is disposed within a detection volume 42 wherein the detection volume does not include the touchpad 30.

It is an aspect of the present invention that there are many simple gestures that can be performed in the detection volume around a proximity sensitive touchpad which can show the advantages of 3D gestures. It is another aspect of the invention that very complicated 3D gestures can be performed as well. However, the simple gestures illustrate the use of the present invention very well.

Three-dimensional gestures include but should not be considered limited to such things as moving the detectable object 32 toward the proximity sensitive touchpad 30, swiping the detectable object over the touchpad in a single direction, swiping the detectable back and forth over the touchpad, moving the detectable object toward the touchpad and then stopping, moving the detectable object toward and then back away from the touchpad, and repeatedly moving the detectable towards and then away from the touchpad.

In an alternative embodiment, any of the gestures above might be performed in a specific region of space around the touchpad 30. Thus, performing a gesture to a right side of the touchpad 30 might invoke a first command, but performing the same gesture to a left side of the touchpad might invoke a second command. The touchpad 30 might also be situated so that a front or back side of the touchpad might also be available for performing the same gesture while obtaining a different response. Consider a mobile telephone with a front side and a back side wherein both sides are accessible.

More complicated gestures can include movements in specific patterns that are more complex than one direction or back and forth motions. Gestures also include actions that may not appear as gestures, such as the movement of a mobile telephone away from the ear of a listener. The movement away from the user's ear could be a gesture that is interpreted as a command to activate a speakerphone and to deactivate an internal speaker. Likewise, moving the mobile telephone back to the user's ear can be a command to deactivate the speakerphone and to reactivate the internal speaker.

The ability to perform and detect a gesture in 3D space is separate from the concept of the specific actions or commands that are being activated through the use of gestures. Thus, the sample gestures described herein should only be considered examples, and the same gestures can be used in an endless variety of devices that include a proximity sensitive touchpad as an interface to the devices.

An example of a specific command that might be performed when using a proximity sensitive touchpad 30 is to wake a device from an off or low power mode. Many electronic devices such as mobile phones, portable digital music players, and other portable electronic devices have a sleep function that dims or turns off a display screen after the device has not been used or moved for a set period of time. In order to “wake up” the display screen, the user is required to physically touch a key or otherwise use the device. The present invention thus provides a method of sending a wake-up command to the device, for example, if the user brings a finger within a pre-determined distance of the device, thus enabling an easier and faster wake-up capability.

Another example of a proximity gesture is scrolling. For example, some portable music players and other portable electronic devices require the user to physically make contact with a touchpad to perform the scrolling function. Using the present invention, a scrolling function can be performed without the need to touch the device which in the case of scrolling on LCD screens permits the user to a) have improved visibility of the screen during the gesture and b) perform the desired command without getting the LCD screen dirty or oily by contact with a user's finger.

As electronic books become more popular, the present invention can provide the ability to turn pages forwards or backwards. Thus a swiping gesture is ideally suited for quickly scrolling pages.

It should be understood that the present invention is not dedicated solely to portable electronic appliances as there are many applications of the present invention for desktop devices or other non-portable appliances. The present invention has particular application for use with a computer display screen that can be difficult to clean after oily skin has made contact with it. Thus, the present invention is not only a quick means of sending commands to electronic devices; it also enables those devices to remain clean.

Once a gesture has been detected, the gesture that has been performed is compared to a database of all possible gestures that correspond to a particular command or function. The electronic appliance then performs the command or function.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for providing input commands to a proximity sensitive device without making physical contact with said device, said method comprising the steps of:
1) providing a proximity sensitive device that is capable of detecting and tracking movement of a detectable object within a detection volume of the device;
2) tracking movement of a detectable object within the detection volume; and
3) determining which gesture has been performed as defined by movement of the detectable object.

2. The method as defined in claim 1 wherein the step of determining which gesture has been performed further comprises the step of:
1) comparing the detected gesture to a database of all possible gestures; and
2) performing a command or function that is associated with the detected gesture.

3. The method as defined in claim 1 wherein the step of detecting and tracking movement of a detectable object within a detection volume further comprises the step of detecting and tracking movement of the detectable object in three dimensions.

4. The method as defined in claim 3 wherein the step of performing a command or function is further comprised of the step of selecting the command or function from the group of commands or functions comprised of tapping, cursor control, scrolling, activating buttons, performing wake-up functions, and turning pages or pictures.

5. The method as defined in claim 1 wherein the method further comprises the steps of:
1) providing a display screen, wherein the touch sensitive device is disposed on top or beneath the display screen; and
2) eliminating a need to touch the display screen in order to input a command or function to the touch sensitive device.

6. The method as defined in claim 1 wherein the method further comprises the step of implementing the detection volume around the touch sensitive device such that the touch sensitive device is within the detection volume.

7. The method as defined in claim 1 wherein the method further comprises the step of implementing the detection volume such that the touch sensitive device is outside the detection volume.

8. The method as defined in claim 1 wherein the method further comprises the step of providing a touchpad as the touch sensitive device, wherein the touchpad can operate as a proximity sensitive device and a touch sensitive device.
